(19) United States
(12) Patent Application Publication
(10) Pub. No.: US 2025/0187211 A1
(43) Pub. Date: Jun. 12, 2025

(54) HOUSING FOR ACCOMMODATING SECTION OF ROBOT ARM AND METHOD FOR MANUFACTURING THE SAME

(71) Applicant: ABB SCHWEIZ AG, Baden (CH)

(72) Inventors: Kaiyuan Cao, Shanghai (CN); Jiafan Zhang, Shanghai (CN)

(21) Appl. No.: 19/057,484

(22) Filed: Feb. 19, 2025

Related U.S. Application Data
(63) Continuation of application No. PCT/CN2022/120924, filed on Sep. 23, 2022.

(51) Int. Cl. B25J 19/00; B25J 9/00

(52) U.S. Cl. CPC B25J 19/0075; B25J 9/0012

(57) ABSTRACT

A housing for accommodating a section of a robot arm used in hygienic application and method for manufacturing the housing. The housing includes a housing body made of a material suitable for contacting product in the hygienic application, and a connector made of a second material having a higher strength than the first material. The housing body has an extension portion configured to accommodate the section of the robot arm, and a connection bore located at an end of the extension portion. The connector has an outer surface, wherein the housing body is connected on at least one portion of the outer surface of the connector to couple the connector onto an inner surface of the connection bore.

### FIELD

Example embodiments of the present disclosure generally relate to housing for accommodating a section of a robot arm and a method of manufacturing the housing, and more particularly, relate to a housing for accommodating a section of the robot arm that is used in hygienic environment.

### BACKGROUND

According to ISO14159:2008 Safety of machinery-Hygiene requirements for the design of machinery, surfaces of materials and coatings shall be durable and capable of being disinfected, without breaks, resistant to cracking, chipping, flaking, erosion, corrosion and abrasion.

In hygienic application, such as food-contact application, in order to be in conformity with those standards, one traditional solution is to paint the outer surface of the robot arm with painting or plate the outer surface of the robot arm with cladding material. However, especially in product contact surfaces, the surface material should be non-toxic and not contaminate or otherwise have any adverse effect on the product, so based on these requirements, the painting solution or plating solution is very risky in high level hygienic application.

Another traditional solution is manufacturing the robot structure by stainless steel, such as ss316, ss304 which are widely used in food & beverage market or pharmaceutical & medical industry. Stainless steel has high oxidation resistance, biologically inertness and resistance to acid-bases and organic materials. However stainless steel, if used as robot structure material, has some shortages: high cost, heavy and poor thermal conductivity.

JP2010115732A discloses a structural material, for arms of robot used in e.g. welding process, has frame layer whose surface comprises radiation layer that is shaped in such a way that fiber orientation is continued from exterior side of arm to inner side of arm. However, this structure material cannot be used for hygienic application because it fails to meet the hygienic design requirement.

U.S. Pat. No. 011,020,851B2 discloses a bag unit that covers the whole robot arm that is used for hygienic application. Since the bag unit has flexibility, the robot arm can be accommodated therein. However, the bag unit has limited work space, short lifetime and poor appearance.

### SUMMARY

In order to address or at least partially address the above and other potential problems, embodiments of the present disclosure provide a housing for accommodating a section of a robot arm, which can have smooth surface and meet the standards for hygienic environment.

In a first aspect, a housing for accommodating a section of a robot arm used in hygienic application is provided. The housing comprises a housing body made of a first material suitable for contacting product in the hygienic application, and a connector made of a second material, wherein the second material has a higher strength than the first material, wherein the housing body comprises an extension portion configured to accommodate the section of the robot arm; and a connection bore located at an end of the extension portion, and the connector comprises an outer surface, wherein the housing body is connected on at least one portion of the outer surface of the connector to couple the connector onto an inner surface of the connection bore. In the housing for a section of the robot arm used in hygienic application, the housing

body is the main part of the housing directly contacting the product in the hygienic application, and the connector is housed in the connection bore of the housing body, and thus the connector is protected by the housing body to the extent that the connector is exposed to the product as little as possible. By manufacturing the housing body by first material suitable for contacting product in the hygienic application and receiving the connector therein, the housing can meet the hygienic requirement and be used for a long time. Further, since the second material, such as aluminum alloy, carbon fiber and high strength plastic, has a higher strength than the first material, the connector can be used to position the actuators therein at the joint of the robot arm so as to ensure that the actuator can be operated in high accuracy.

In some embodiments, the first material is plastic, and the housing body is connected on the at least one portion of the outer surface of the connector by overmolding the plastic on the outer surface. In this embodiment, due to corrosion-resistance, low density, low cost and good formability performance of the plastic material, the housing body can have light weight and smooth appearance, and can be manufactured in a low-cost way and can meet hygiene requirements. Further, the housing body can be formed by overmoling the plastic on the outer surface of the connector. Therefore, the housing body and hence the housing can be manufactured in an easy and low cost way.

In some embodiments, the housing body may be connected on the at least one portion of the outer surface of the connector such that a portion of the outer surface of the connector is located outside the connection bore, and the housing may further comprise a product contact component made of a third material suitable for contacting the product in the hygienic application and having a higher strength than the first material wherein the product contact component is coupled on the portion of the outer surface of the connector. By providing this product contact component made of the third material and disposed this product contact component between surfaces, opposite to each other, of connection bores of adjacent sections, the friction between two adjacent sections at the joint can be reduced, considering that the metal martial is wear-resistant.

In some embodiments, the product contact component may be coupled onto the portion of the outer surface before connecting the housing body on the outer surface of the connector. By coupling the product contact component onto the portion of the outer surface of the connector before connecting, as compared to coupling them after connecting, it will be much easier to fit the product contact component to the connector.

In some embodiments, the second material may be aluminum alloy, and the third material may be stainless steel. By selecting the second material to be aluminum alloy, the housing will be less weight, and by selecting the third material to be stainless steel, the product contact component can be corrosion-resistant.

In some embodiments, the housing body may be connected on the at least one portion of the outer surface of the connector such that a portion of the outer surface of the connector is located outside the connection bore, wherein the housing further comprises a sealing ring surrounding the portion of the outer surface of the connector. By providing the sealing ring, liquid product will be isolated from the inner components inside the housing, and the housing will be reliably sealed.

In some embodiments, the product contact component may comprise a shoulder at an outer edge thereof opposite to the housing body; and the housing further comprises a sealing ring received in the shoulder of the product contact component. By providing the sealing ring, liquid product will be isolated from the inner components inside the housing, and the housing will be reliably sealed.

In some embodiments, the extension portion may extend in a direction perpendicular to an axis of the connection bore. By providing the extension portion of a first section perpendicular to the connection bore, the housing for this section can be a first kind of section of the robot arm.

In some embodiments, the extension portion may extend in a direction parallel to an axis of the connection bore. By providing the extension portion parallel to the connection bore, the housing for this section can be a second kind of section of the robot arm perpendicular to the first kind of section.

In some embodiments, the connector may comprise an outer ridge on the outer surface, the connection bore comprises a recess on the inner surface, and the outer ridge may be configured to be received in the recess so as to be fixed and positioned in place with respect to the connection bore. By providing the ridge and the recess, the engagement between the connector and the connection bore can be improved so as to prevent separation from each other.

In some embodiments, the connector may comprise an inner ridge provided with a plurality of connection holes for connecting the connector of a first housing for a first section of the robot arm to a second housing for a second section of the robot arm engaged with the first housing. By providing the inner ridge and connection holes thereon, the first section and the second section can be connected to each other tightly.

In a second aspect, a method for manufacturing a housing for a section of a robot arm used in hygienic application is provide, and the housing comprises a housing body and a connector located at an end of the housing body. The method comprises forming the connector by a second material, wherein the connector has an outer surface, forming the housing body by a first material suitable for contacting product in the hygienic application, wherein the second material has a higher strength than the first material; and connecting the housing body on at least one portion of the outer surface of the connector.

In the housing for a section of the robot arm, the housing body is the main part of the housing directly contacting the product in the hygienic application, and the connector is housed in the connection bore of the housing body; and thus the connector is protected by the housing body to the extent that the connector is exposed to the product as little as possible. By manufacturing the housing body by first material suitable for contacting product in the hygienic application and receiving the connector therein, the housing can meet the hygienic requirement and be used for a long time. Further, since the second material, such as aluminum alloy, carbon fiber and high strength plastic, has a higher strength than the first material, the connector can be used to position the actuators therein at the joint of the robot arm so as to ensure that the actuator can be operated in high accuracy.

In some embodiments, the first material is plastic, and forming the housing body by the first material comprises: placing the connector into a mold corresponding to a shape of the housing, and injecting molten plastic into the mold so as to overmold the molten plastic on the at least one portion of the outer surface of the connector so as to form the housing body. In this embodiment, due to corrosion-resistance, low density; low cost and good formability performance of the plastic material, the housing body can have light weight and smooth appearance, and can be manufactured in a low-cost way and can meet hygiene requirements. Further, the housing body can be formed by overmoling the plastic on the outer surface of the connector. Therefore, the housing body and hence the housing can be manufactured in an easy and low cost way.

In some embodiments, the housing may further comprises a product contact component made of a third material suitable for contacting the product in the hygienic application and having a higher strength than the first material, the outer surface of the connector comprises a first portion and a second portion, wherein the forming the connector further comprises: forming the product contact component made of the third material; and fitting the product contact component onto the first portion of the outer surface of the connector. In this embodiment, by providing this product contact component made of third material and disposed this product contact component between surfaces, opposite to each other, of connection bores of adjacent sections, the friction between two adjacent sections at the joint can be reduced, considering that the metal martial is wear-resistant.

It is to be understood that the Summary is not intended to identify key or essential features of embodiments of the present disclosure, nor is it intended to be used to limit the scope of the present disclosure. Other features of the present disclosure will become easily comprehensible through the description below.

### BRIEF DESCRIPTION OF THE DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1A illustrates a side view of a robot arm according to an embodiment of the present disclosure;

FIG. 1B illustrates a partial perspective view of two portions of a robot arm that are installed together according to an embodiment of the present disclosure;

FIG. 1C illustrates an exploded view of two portions of the robot arm as shown in FIG. 1B according to an embodiment of the present disclosure;

FIG. 1D illustrates a cross-sectional view of two portions of the robot arm as shown in FIG. 1B according to an embodiment of the present disclosure;

FIG. 2A illustrates a perspective view of a housing for accommodating a section of the robot arm according to an embodiment of the present disclosure;

FIG. 2B illustrates another perspective view of the housing for accommodating the section of the robot arm as shown in FIG. 2A according to an embodiment of the present disclosure;

FIG. 3A illustrates a partial cross-sectional view of the housing for accommodating the section of the robot arm as shown in FIG. 2A according to an embodiment of the present disclosure;

FIG. 3B illustrates an exploded view of the housing as shown in FIG. 3A according to an embodiment of the present disclosure;

FIG. 3C illustrates an enlarged view of a portion of the housing as shown in FIG. 3A according to an embodiment of the present disclosure;

FIG. 3D illustrates a perspective view of an assembly composed of a connector and a product contact component according to an embodiment of the present disclosure;

FIG. 4A illustrates a cross-sectional view of the housing for accommodating another section of the robot arm according to an embodiment of the present disclosure;

FIG. 4B illustrates an enlarged view of a portion of the housing for accommodating another section of the robot arm according to an embodiment of the present disclosure; and

FIG. 5 illustrates a flowchart for manufacturing the housing for accommodating a section of the robot arm according to embodiments of the present disclosure.

Throughout the drawings, the same or corresponding reference symbols refer to the same or corresponding parts.

### DETAILED DESCRIPTION

The subject matter described herein will now be discussed with reference to several example embodiments. These embodiments are discussed only for the purpose of enabling those skilled persons in the art to better understand and thus implement the subject matter described herein, rather than suggesting any limitations on the scope of the subject matter.

The term “comprises” or “includes” and its variants are to be read as open terms that mean “includes, but is not limited to.” The term “or” is to be read as “and/or” unless the context clearly indicates otherwise. The term “based on” is to be read as “based at least in part on.” The term “being operable to” is to mean a function, an action, a motion or a state that can be achieved by an operation induced by a user or an external mechanism. The term “one embodiment” and “an embodiment” are to be read as “at least one embodiment.” The term “another embodiment” is to be read as “at least one other embodiment.”

Unless specified or limited otherwise, the terms “mounted,” “connected,” “supported,” and “coupled” and variations thereof are used broadly and encompass direct and indirect mountings, connections, supports, and couplings. Furthermore, “connected” and “coupled” are not restricted to physical or mechanical connections or couplings. In the description below, like reference numerals and labels are used to describe the same, similar or corresponding parts in the figures. Other definitions, explicit and implicit, may be included below.

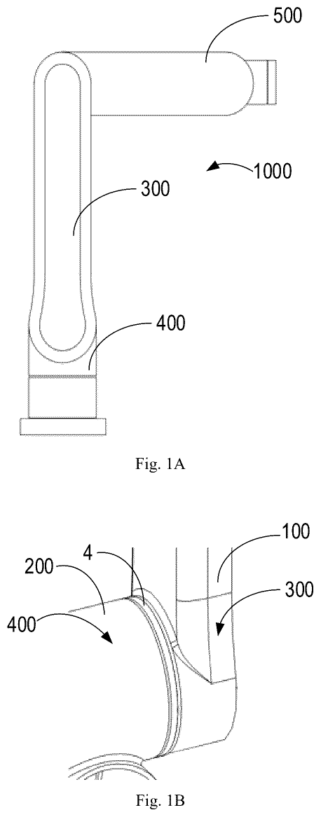

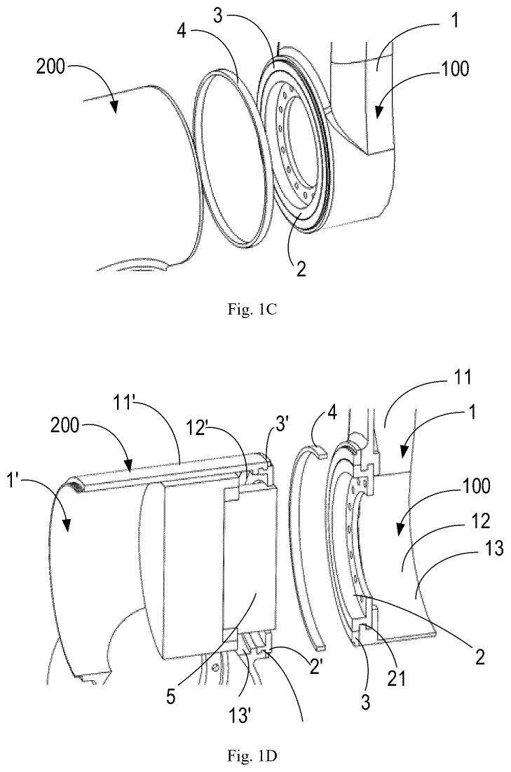

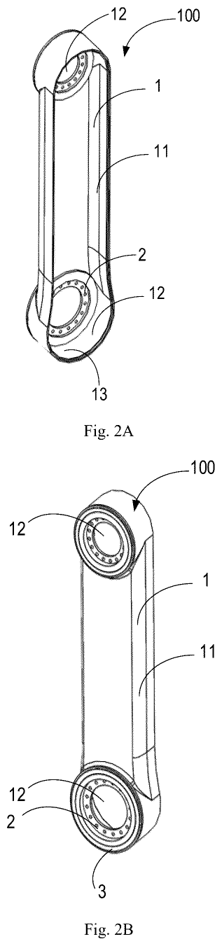

Embodiments of the present invention will be described in detail with reference to FIG. 1A to FIG. 5 hereinafter.

First, the robot arm 1000 used in the hygiene application will be described with reference to FIG. 1A to FIG. 1D.

FIG. 1A illustrates a side view of a robot arm according to an embodiment of the present disclosure; FIG. 1B illustrates a partial perspective view of two portions of a robot arm that are installed together according to an embodiment of the present disclosure; FIG. 1C illustrates an exploded view of two portions of the robot arm as shown in FIG. 1B according to an embodiment of the present disclosure; and FIG. 1D illustrates a cross-sectional view of two portions of the robot arm as shown in FIG. 1B according to an embodiment of the present disclosure.

As shown in FIG. 1A, a robot arm 1000 comprises a plurality of sections, such as sections 300, 400 and 500. The robot arm 1000 is used in hygienic application, wherein hygiene requirements for the design of machinery; surfaces of materials and coatings shall be durable and capable of being disinfected, without breaks, resistant to cracking, chipping, flaking, erosion, corrosion and abrasion.

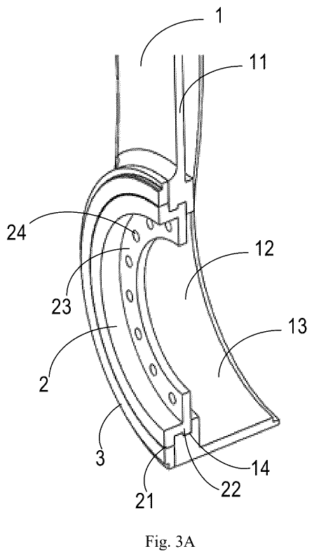

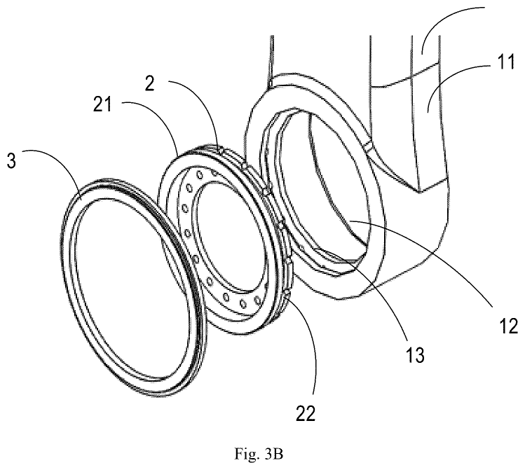

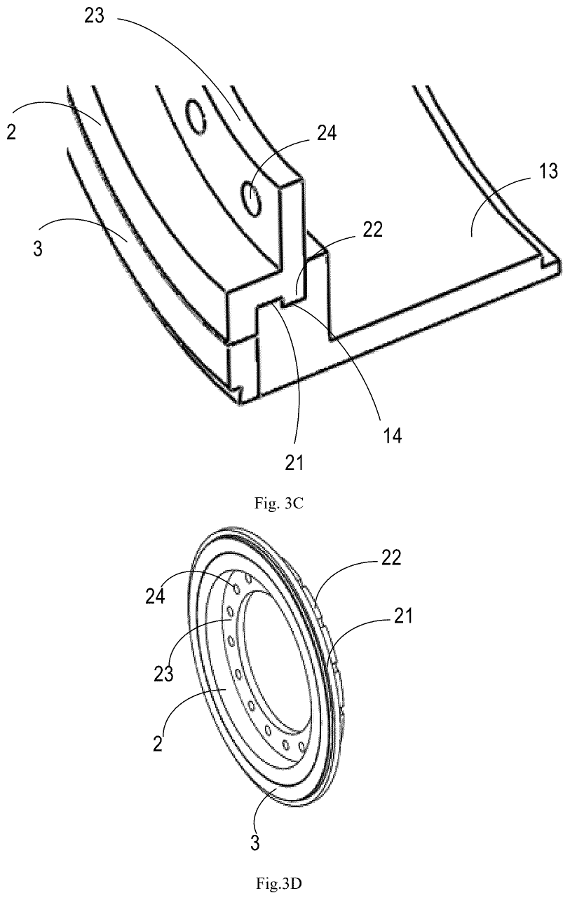

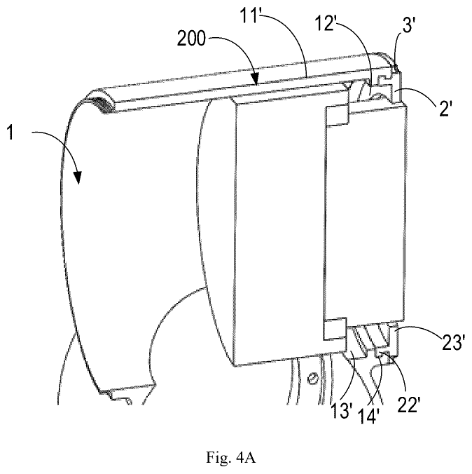

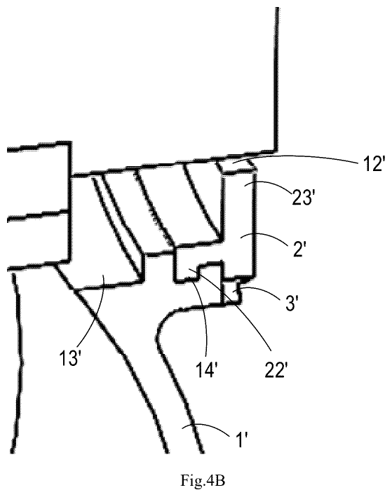

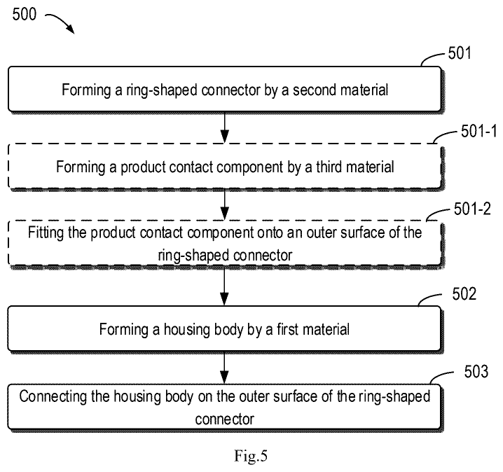

As shown in FIG. 1B, the section 300 and the section 400 are installed to each other and can rotate with respect to each other. It should be understood that the section 300 and the section 500 are also installed to each other and can rotate with respect to each other. The section 300 has a housing 100, and the section 400 has a housing 200. The housing 100 for the section 300 is shown in details in FIGS. 2A to 3D, whereas the housing 200 for the section 400 is shown in details in FIG. 1D and FIGS. 4A and 4B, which will be described hereinafter. As shown in FIG. 1C and FIG. 1D, the section 300 can be rotated with respect to the section 400. A rotatable component such as a shaft 51 driven to rotate by the actuator (not shown) is fixed or stationary with respect to one (such as the section 300 as shown in FIG. 1B) of the section 300 and the section 400, and a fixed component, such as a bearing (not shown) is fixed or stationary with respect to the other (such as the section 400 as shown in FIG. 1B) of the section 300 and the section 400. The rotatable component is rotatable with respect to the fixed component such that the section 300 can be rotated with respect to the section 400.

The housing 100 for the section 300 will be described hereinafter with reference to FIGS. 2A to 3D. FIG. 2A illustrates a perspective view of a housing for accommodating a section of the robot arm according to an embodiment of the present disclosure; FIG. 2B illustrates another perspective view of the housing for accommodating the section of the robot arm as shown in FIG. 2A according to an embodiment of the present disclosure; FIG. 3A illustrates a partial cross-sectional view of the housing for accommodating the section of the robot arm as shown in FIG. 2A according to an embodiment of the present disclosure; FIG. 3B illustrates an exploded view of the housing as shown in FIG. 3A according to an embodiment of the present disclosure; FIG. 3C illustrates an enlarged view of a portion of the housing as shown in FIG. 3A according to an embodiment of the present disclosure; and FIG. 3D illustrates a perspective view of an assembly composed of a connector and a product contact component according to an embodiment of the present disclosure.

As shown in FIGS. 2A to 2B and FIGS. 3A to 3D, the housing 100 comprises a housing body 1 made of a first material suitable for contacting product in the hygienic application, such as plastic, and a connector 2 made of second material having a higher strength than the first material,, such as aluminum alloy, carbon fiber and high strength plastic which has high strength and light weight. The housing body 1 is configured to accommodate the components for the section 300, and is the main part that directly contacts the product in the hygienic application. The connector 2 as shown in FIGS. 2A to 2B and FIGS. 3A to 3D, is of ring shape, however, the shape of the connector 2 is not limited to the ring shape, as long as the rotatable component (such as a shaft 5) can be connected to the connector 2 such that the section 300 can rotate with respect to the section 400. For example, the connector 2 can be a flange, or a disc that can be connected to the actuator 5.

In the illustrated embodiment, the housing body 1 comprises an extension portion 11 configured to accommodate the section 300 of the robot arm; and two connection bores 12 located at two ends of the extension portion 11. As shown in FIGS. 2A to 2B and FIGS. 3A to 3D, the extension portion 11 extends in a first direction, whereas the central axis of the connection bore 12 extends in a second direction which is perpendicular to the first direction. The section 300 of the robot arm 1000 is connected to two other sections 400 and 500 of the robot arm, and thus two connection bores 12 are formed at two ends thereof. It should be understood by the person skilled in the art that the connection bore can be only formed at one end of the connection body of the section, if this section is connected to only one other section.

As shown in FIGS. 2A to 2B and FIGS. 3A to 3D, the connector 2 is provided at a joint of the robot arm 1000, provided at one end or two end of the housing body and configured to position the actuators (not shown) therein at the joint of the robot arm. As illustrated, most portion of the connector 2 is received in the connection bore 12 such that the connector 2 is exposed to the product as little as possible.

In the housing for a section of the robot arm used in hygienic application, the housing body is the main part of the housing directly contacting the product in the hygienic application, and the connector is housed in the connection bore of the housing body, and thus the connector is protected by the housing body to the extent that the connector is exposed to the product as little as possible. By manufacturing the housing body by first material suitable for contacting product in the hygienic application and receiving the connector therein, the housing can meet the hygienic requirement and be used for a long time. Further, since the second material, such as aluminum alloy, carbon fiber and high strength plastic, has a higher strength than the first material, the connector can be used to position the actuators (not shown) therein at the joint of the robot arm so as to ensure that the actuator can be operated in high accuracy.

In one embodiment, as shown in FIGS. 2A to 2B and FIGS. 3A to 3D, the housing body 1 is made of plastic material, and can be connected on at least one portion of the outer surface 21 of the connector 2 by overmolding, so as to fasten or couple the connector 2 onto an inner surface 13 of the connection bore 12. When overmolding, the connector 2 can be placed in the mold first, and then molten plastic material can be injected into the mold to overmold the housing body 1 on the outer surface 21 of the connector 2. The mold can be pre-formed to have a shape corresponding to the section 300. In this embodiment, due to corrosion-resistance, low density, low cost and good formability performance of the plastic material, the housing body can have light weight and smooth appearance, and can be manufactured in a low-cost way and can meet hygiene requirements. Further, the housing body can be formed by overmoling the plastic on the outer surface of the connector. Therefore, the housing body and hence the housing can be manufactured in an easy and low cost way.

In other embodiment, not shown, the housing body 1 can also be made of other material suitable for the hygiene application, such as stainless steel tube and profile-tube made from other material. Compared to the material made by casting, the profile-tube has no fine pores on the outer surface, and thus can be resistant to the acid-bases and can be used in hygiene application for a long time. When connecting the housing body to the connector, the housing body can be fastened to the connector by a bolt or a screw. Further, in order to support the connector, some other components having shape corresponding to the connector may be provided inside the profile tube.

The housing 200 for the section 400 will be described with reference to FIG. 1D and FIGS. 4A to 4B. FIG. 4A illustrates a cross-sectional view of the housing for accommodating another section of the robot arm according to an embodiment of the present disclosure; and FIG. 4B illustrates an enlarged view of a portion of the housing for accommodating another section of the robot arm according to an embodiment of the present disclosure.

As shown in FIG. 1D, the housing 200 comprises a housing body 1′ made of a first material suitable for contacting product in the hygienic application, such as plastic, and a connector 2′ made of a second material having a higher strength than the first material, such as aluminum alloy, carbon fiber and high strength plastic which has high strength and light weight. The housing body 1′ is configured to accommodate the components for the section 400, and is the main part that directly contacts the product in the hygienic application.

In the illustrated embodiment, the housing body 1′ comprises an extension portion 11′ configured to accommodate the section 400 of the robot arm; and an connection bore 12′ located at one end of the extension portion 11′. Since this section 400 is only connected to one other section, such as the section 300, only one connection bore 12′ is formed at one end of the extension portion. In the illustrated embodiment, the connection bore 12′ is coaxial to the extension portion 11′.

As shown in FIGS. 1D, 4A to 4B, the connector 2′ is provided at a joint of the robot arm 1000 and configured to position the actuators (not shown) therein at the joint of the robot arm. As illustrated, most portion of the connector 2′ is received in the connection bore 12′ such that the connector 2′ is exposed to the product as little as possible.

In the housing for a section of the robot arm used in hygienic application, the housing body is the main part of the housing directly contacting the product in the hygienic application, and the connector is housed in the connection bore of the housing body, and thus the connector is protected by the housing body to the extent that the connector is exposed to the product as little as possible. By manufacturing the housing body by first material suitable for contacting product in the hygienic application and receiving the connector therein, the housing can meet the hygienic requirement and be used for a long time. Further, since the second material, such as aluminum alloy, carbon fiber and high strength plastic, has a higher strength than the first material, the connector can be used to position the actuators (not shown) therein at the joint of the robot arm so as to ensure that the actuator can be operated in high accuracy.

In one embodiment, as shown in FIG. 1D and FIGS. 4A-4B, the housing body 1′ can be made of plastic material, and can be overmolded on at least one portion of the outer surface 21′ of the connector 2′ so as to fasten or couple the connector 2′ onto an inner surface 13′ of the connection bore 12′. When overmolding, the connector 2′ can be placed in the mold first, and then molten plastic material can be injected into the mold to overmold the housing body on the outer surface of the connector 2′. The mold can be pre-formed to have a shape corresponding to the section 300. In this embodiment, due to corrosion-resistance, low density; low cost and good formability performance of the plastic material, the housing body can have light weight and smooth appearance, and can be manufactured in a low-cost way and can meet hygiene requirements. Further, the housing body can be formed by overmoling the plastic on the outer surface of the connector. Therefore, the housing body and hence the housing can be manufactured in an easy and low cost way.

In other embodiment, not shown, the housing body 1′ can also be made of other material suitable for the hygiene application, such as stainless steel tube and profile-tube made from other material. Compared to the material made by casting, the profile-tube has no fine pores on the outer surface, and thus can be resistant to the acid-bases and can be used in hygiene application for a long time. When connecting the housing body to the connector, the housing body can be fastened to the connector by a bolt or a screw. Further, in order to support the connector, some other components having shape corresponding to the connector may be provided inside the profile tube.

In one embodiment, the housing body 1, 1′ can be connected on the whole outer surface 21, 21′ of the connector 2, 2′. In another embodiment, the housing body 1, 1′ can be connected on part of the outer surface 21, 21′ of the connector 2, 2′ such that some other component, such as product contact component 3, 3′, which will be described below, can be provided on the outer surface 21, 21′ so as to isolate the extension portions 11, 11′ from each other and reduce the friction between these two extension portions 11, 11′, considering that the plastic material for extension portion is less wear-resistant.

In order to protect the connector 2, 2′ from being corroded, it is preferred to prevent the connector from directly contacting the product. As shown in FIGS. 3A to 3D and FIGS. 4A and 4B, the outer surface 21, 21′ of the connector 2, 2′ can comprise a portion that located outside the connection bore 12, 12′ and exposed to the product, and the other portion that located inside the connection bore 12, 12′. In the illustrated embodiment, the housing 100, 200 further comprises a product contact component 3, 3′ which is made of a third material suitable for contacting the product in the hygienic application and having a higher strength than the first material,, such as stainless steel, and configured to be in direct contact with the product that is operated with the robot arm. The product contact component 3, 3′ is fitted or coupled on the exposed portion of the outer surface 21, 21′ of the connector 2, 2′ so as to form as a single body, before connecting the housing body 1, 1′ on the outer surface of the connector 2, 2′. In one example, the product contact component 3, 3′ can be press-fitted on the exposed portion of the outer surface 21, 21′. In another example, the product contact component 3, 3′ can be bolted to the exposed portion of the outer surface 21, 21′. When overmoling the housing body on the connector, after forming the single part comprising the product contact component and the connector, the single part can be placed in the mold first, and then molten plastic material can be injected into the mold to overmold the housing body 1, 1′on a portion of the outer surface of the connector 2, 2′.

In this embodiment, since the product contact component 3, 3′ exposed to the product directly, is made of metal, such as stainless steel, the inner component, such as connector 2, 2′, can be isolated from the product, and the corrosion to the inner component can be prevented or reduced. Further, the product contact component 3, 3′ is also located between adjacent surfaces of two adjacent housings 100, 200, and due to wear-resistance of the stainless steel, the friction between the adjacent housing bodies can be reduced.

In some situation, the product is liquid, and the liquid can invade into the housing. There is a need to seal the inner component housed in the housing from the liquid product. As shown in FIGS. 1C and 1D, the housing 100 or the housing 200 further comprises a sealing ring 4.

In one embodiment (not shown), a first part of the sealing ring 4 is directly fitted on a portion of the outer surface 21 of the connector 2 which is exposed to the product, and a second part of the sealing ring 4 is directly fitted on a portion of the outer surface 21′ of the connector 2′ which is exposed to the product. In one embodiment shown in FIGS. 1C and 1D, the sealing ring 4 is directly fitted on the product contact component 3, 3′. In the illustrated embodiment, the product contact component 3, 3′ has a shoulder 31, 31′ at an outer edge thereof opposite to the housing body 1, 1′, and the sealing ring 4 is received in the shoulders 31, 31′ of the product contact component 3, 3′. Specifically, a first part of the sealing ring 4 is fitted on the shoulder 31, and a second part of the sealing ring 4 is fitted on the shoulder 31′.

In this embodiment, since the sealing ring is provided, the liquid product is isolated from the inner components by the sealing ring and the corrosion to the inner components is further reduced.

As shown in FIG. 3C and FIG. 4B, the connector comprises an outer ridge 22, 22′ on the outer surface 21, 21′ of the connector 2, 2′, and the connection bore 12, 12′ comprises a recess 14, 14′ on the inner surface 13, 13′. The outer ridge 22, 22′ is configured to be received in the recess 14, 14′ so as to be fixed and positioned in place with respect to the connection bore 12, 12′ of the housing body 1, 1′. It should be understood by the person skilled in the art that the engagement between the connector 2, 2′ and the housing body 1, 1′ can be other performed in other way, and the recess also can be formed on the connector, and the outer ridge can also be formed on the housing body, and the ridge can be divided into a plurality of segments.

In this embodiment, by the engagement between the recess and the outer ridge, the connection between the connector and the connection bore can be further improved. In addition to the facing boding between the inner surface of connection bore and the outer surface of the connector, and the connector can be connected to and positioned to the connection bore by the engagement force between the recess and the ridge, which is more stable than the facing boding.

As shown in FIGS. 2A, 2B, 3A and 3B, the connector 2 further comprises an inner ridge 23, and the inner ridge is provided with a plurality of connection holes 24 for connecting the connector 2 of a first housing 100 for a first section 300 of the robot arm to a second housing 200 (such as connected to the shaft 5 which is rotatable, as shown in FIG. 1D) for a second section 400 of the robot arm engaged with the first housing 100, such as by bolting. It should be understood by the person skilled in the art that the connector 2′ is also provided with an inner ridge 23, which is provided with the respective connection holes for bolting, for example, the fixed component (such as a bearing that can be rotated with respect to the rotatable component). By providing the inner ridge and connection holes thereon, the section 300 and the section 400 can be connected to each other tightly.

In the following, it will describe the method for manufacturing the housing.

FIG. 5 illustrates a flowchart for manufacturing the housing for accommodating a section of the robot arm according to embodiments of the present disclosure.

As shown in FIG. 5, the method starts at block 501, in which, the connector 2, 2′ is formed by a second material, such as aluminum alloy, carbon fiber and high strength plastic. At block 502, the housing body 1, 1′ is formed by a first material suitable for contacting product in the hygienic application. At block 503, the housing body 1, 1′ is connected on at least one portion of the outer surface of the connector 2, 2′. In one embodiment, the housing body 1, 1 can be connected on the whole outer surface 21, 21′ of the connector 2, 2′. In another embodiment, the housing body 1, 1′ can be connected on a part of the outer surface 21, 21′ of the connector 2, 2′ such that some other component, such as product contact component 3, 3′, which will be described below, can be provided on the outer surface 21, 21′ so as to isolate the extension portions 11, 11′ from each other and reduce the friction between these two extension portions 11, 11′, considering that the plastic material for extension portion is less wear-resistant.

Connecting the housing body to the connector can be performed by overmoling the first material onto the connector, or performed by connecting the already-formed housing body to the connector by a screw or a bolt.

Optionally, the housing 100, 200 further comprise the product contact component 3, 3′, which is fitted to the connector 2, 2′. The method optionally comprises a block 501-1, in which, the product contact component 3, 3′ is formed by a third material, such as stainless steel, and a block 501-2, in which, the product contact component is fitted onto one portion of the outer surface 21, 21′ of the connector 2, 2′.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. On the other hand, various features that are described in the context of a single embodiment may also be implemented in multiple embodiments separately or in any suitable sub-combination.

Compared with the conventional approaches, by manufacturing the housing body by first material suitable for contacting product in the hygienic application and receiving the connector therein, the housing can meet the hygienic requirement and be used for a long time. Further, since the second material, such as aluminum alloy, carbon fiber and high strength plastic, has a higher strength than the first material, the connector can be used to position the actuators (not shown) therein at the joint of the robot arm so as to ensure that the actuator can be operated in high accuracy.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A housing for accommodating a section of a robot arm in hygienic application, comprising:
a housing body made of a first material suitable for contacting product in the hygienic application, comprising:
an extension portion configured to accommodate the section of the robot; and
a connection bore located at an end of the extension portion, and
a connector made of a second material and comprising an outer surface, wherein the second material has a higher strength than the first material,
wherein the housing body is connected on at least one portion of the outer surface of the connector to couple the connector onto an inner surface of the connection bore.

2. The housing of claim 1, wherein the first material is plastic, and the housing body is connected on the at least one portion of the outer surface of the connector by overmolding the plastic on the outer surface.

3. The housing of claim 1, wherein the housing body is connected on the at least one portion of the outer surface of the connector such that a portion of the outer surface of the connector is located outside the connection bore, and
the housing further comprises a product contact component made of a third material suitable for contacting the product in the hygienic application and having a higher strength than the first material,
wherein the product contact component is coupled on the portion of the outer surface of the connector.

4. The housing of claim 3, wherein the product contact component is coupled onto the portion of the outer surface before connecting the housing body on the outer surface of the connector.

5. The housing of claim 3, wherein the second material is aluminum alloy, and the third material is stainless steel.

6. The housing of claim 1, wherein the housing body is connected on the at least one portion of the outer surface of the connector such that a portion of the outer surface of the connector is located outside the connection bore ,
wherein the housing further comprises a sealing ring surrounding the portion of the outer surface of the connector.

7. The housing of claim 3, wherein the product contact component comprises a shoulder at an outer edge thereof opposite to the housing body, and
the housing further comprises a sealing ring received in the shoulder of the product contact component.

8. The housing of claim 1, wherein the extension portion extends in a direction perpendicular to an axis of the connection bore.

9. The housing of claim 1, wherein the extension portion extends in a direction parallel to an axis of the connection bore.

10. The housing of claim 1, wherein the connector comprises an outer ridge on the outer surface,
the connection bore comprises a recess on the inner surface, and
the outer ridge is configured to be received in the recess so as to be fixed and positioned in place with respect to the connection bore.

11. The housing of claim 1, wherein the connector comprises an inner ridge provided with a plurality of connection holes for connecting the connector of a first housing for a first section of the robot arm to a second housing for a second section of the robot arm engaged with the first housing.

12. A method for manufacturing a housing for a section of a robot arm used in hygienic application, the housing comprising a housing body and a connector located at an end of the housing body, comprising:
forming the connector by a second material, wherein the connector has an outer surface;
forming the housing body by a first material suitable for contacting product in the hygienic application, wherein the second material has a higher strength than the first material; and
connecting the housing body on at least one portion of the outer surface of the connector.

13. The method of claim 12, wherein the first material is plastic, and forming the housing body by the first material comprises:
placing the connector into a mold corresponding to a shape of the housing, and
injecting molten plastic into the mold so as to overmold the molten plastic on the at least one portion of the outer surface of the connector so as to form the housing body.

14. The method of claim 12, wherein the housing further comprises a product contact component made of a third material suitable for contacting the product in the hygienic application and having a higher strength than the first material, the outer surface of the connector comprises a first portion and a second portion
wherein the forming the connector further comprises:
forming the product contact component made of the third material; and
fitting the product contact component onto the first portion of the outer surface of the connector.
